(19) United States
(12) Patent Application Publication
(10) Pub. No.: US 2007/0298774 A1
(43) Pub. Date: Dec. 27, 2007

(54) PHONE SERVICE FEATURE FOR CONVENIENT IDENTIFICATION OF CALLBACK NUMBER

(75) Inventors: Indran Naick, Cedar Park, TX (US); Jeffrey K. Wilson, Austin, TX (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/425,418

(22) Filed: Jun. 21, 2006

(51) Int. Cl. H04M 3/42

(52) U.S. Cl. 455/415; 455/417

(57) ABSTRACT

A method and computer program product for providing callback telephone numbers with a telephone message calls for prompting for selection of callback numbers and corresponding events (such as time) for transitioning from one callback number to the next. The teachings provide for use of aspects of existing communications infrastructure such as caller identification displays.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The teachings herein relate to telephone messaging, and more specifically to techniques for providing user defined information for rapid and reliable access thereto.

2. Description of the Related Art

Occasionally, voice mails are left with long rambling messages. These messages are basically simple recordings devoid of “meta data.” For example, consider listening to a long message where the callback number is said quickly, unclearly, and at the end of the long message. In some systems, the long message must be listened to in its entirety to review the callback number. Typical exceptions to this problem include voice mail systems for cell phones and some corporate phone systems which record the original call time and the originating caller's number.

In these exceptions, using the logged number, a message recipient may call back a number through the features of the applicable system. However, one problem, even with these systems, is that some “caller” numbers do not coincide with the caller's real callback number. Further complications with reaching the caller arise when considering that the caller might initially use one number as a call back number but wish to use another number after some amount of time. Such information may be easily left in a voice message, however, this can lead to the first problem of long and unclear messages. In some automated systems, such features are not currently available.

What is needed is a technique for providing readily accessible information along with a voice message. Preferably, the technique permits a caller to dynamically define relevant data and a receiver to obtain the relevant data separately from retrieval of the voice message.

### SUMMARY OF THE INVENTION

The shortcomings of the prior art are overcome and additional advantages are provided through the provision of a method and computer program product for providing callback number information with a message, including: receiving a call completion request from a caller, wherein upon a failure of call completion a messaging sequence is initiated; upon initiation of the messaging sequence, providing a prompt for selecting a first callback number and a corresponding event designation; retaining the first callback number and corresponding event designation; providing another prompt for selecting additional callback numbers and corresponding events to provide a plurality of additional callback numbers and corresponding event designations; retaining the plurality of additional callback numbers and corresponding event designations; monitoring for occurrence of designated events; and upon occurrence of a designated event, providing the corresponding callback number with the message.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which computer program product stored on machine readable media and includes instructions for providing callback number information with a message, the instructions providing instructions for: receiving a call completion request from a caller, wherein upon a failure of call completion a messaging sequence is initiated; upon initiation of the messaging sequence, providing a prompt for one of manually, semi-automatically and automatically selecting a first callback number and a corresponding event designation, wherein a designated event includes one of a time and a status retaining the first callback number and corresponding event designation; providing another prompt for one of manually, semi-automatically and automatically selecting additional callback numbers and corresponding events to provide a plurality of additional callback numbers and corresponding event designations; wherein automatically selecting includes automatically providing a callback number data table; retaining the plurality of additional callback numbers and corresponding event designations; monitoring a system clock for occurrence of designated events; and upon occurrence of a designated event, providing the corresponding callback number with the message by at least one of displaying the callback number in a caller identification display reciting the callback number.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a communications infrastructure;

FIG. 2 illustrates arrangements for storing callback numbers and inactivation times; and

FIG. 3 illustrates one example for manual entry of call back numbers.

The detailed description explains the preferred embodiments of the invention, together with advantages and features, by way of example with reference to the drawings.

### DETAILED DESCRIPTION OF THE INVENTION

The teachings herein provide for separating certain information from telephone voice messages and dynamically updating the information. More specifically, a user is provided with an ability to record and provide a callback number along with (e.g., separately from) a traditional voice message. The user can provide a plurality of callback numbers which are managed according to certain events (such as the passage of time). For example, a first callback number is provided for use as the callback number up until a predetermined time, and a second callback number is provided for use after the predetermined time. Automatic switching of callback numbers from the first callback number to the second callback number occurs at the predetermined time. Other aspects will become apparent when considering this disclosure as a whole.

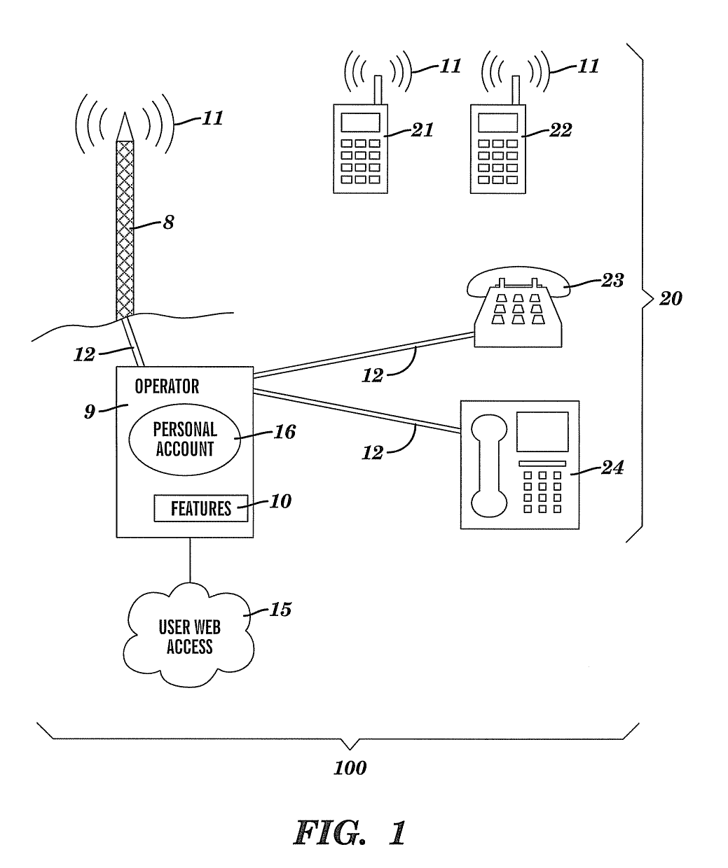

Referring to FIG. 1, aspects of an exemplary communications infrastructure 100 are shown. The communications infrastructure 100 depicted herein includes a plurality of communications devices 20. Exemplary communications devices 20 include mobile stations, such as a cellular telephone 21 and a satellite telephone 22. Typically, the mobiles stations communicate with the communications infrastructure 100 by use of a radio signal 11 produced by a radio tower 8. Other communications devices 20 include fixed stations such as and without limitation, a home telephone 23 and a business telephone 24. Typically, the fixed stations communicate with the communications infrastructure 100 by use of communications lines 12.

In typical embodiments, the communications infrastructure 100 is managed by an operator 9. As used herein, the operator 9 includes all resources necessary for operating and maintaining the communications infrastructure 100. Exemplary components, generally not depicted herein (for purposes of simplicity), include, without limitation: computers and components thereof, power supplies, personnel, communications networks, etc. As examples of components of the operator 9, the communications lines 12 as well as the radio signal 11 are used to connect a base station (not shown) of the operator 9 with the various communications devices 20.

In some embodiments, users are provided access to and control over a personal account 16 maintained by the operator 9. Exemplary types of access include user web access 15 available through the Internet.

In typical embodiments, the operator 9 maintains voice mail for each user. In these embodiments, a voice mail account is associated with each personal account 16. Access to voice mail may be had through remote systems, such as through the user web access 15 or through one of the communications devices 20.

The communications infrastructure may include any one or more of a cellular network, a fixed network, a private network (such as a corporate network), or any other type of communications infrastructure 100.

A calling feature 10 for the communications infrastructure 100, as disclosed herein, may be implemented through various techniques. For example, the calling feature 10 may be implemented as software including machine readable instructions stored as a computer program product. The computer program product, or software, may be stored using any one or more of a variety of media. Non-limiting examples of media include, magnetic media, optical media, magneto-optical media, read-only memory (TOM), random-access memory (RAM), a flash memory, a hard drive, a tape drive and others. Typically, the storage is a part of the operator 9. However, in some embodiments, the storage may be included, at least in part within the communications devices 20. In one embodiment, at least a portion of the calling feature 10 is manually implemented by call center personnel.

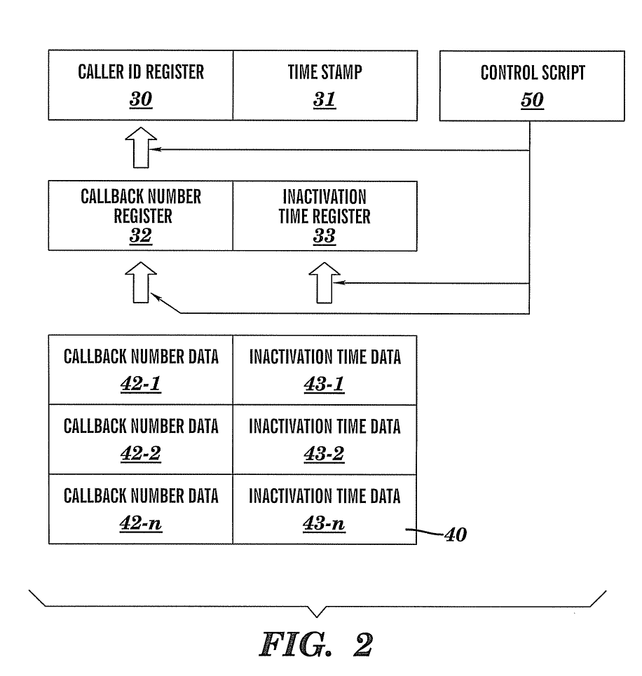

In order to provide some context for the calling feature 10, consider aspects of some present day systems. In some present (prior art) systems, a telephone number for the caller is maintained separately from message data. For example, in a typical cellular communications network, a user is provided with an automated verbal recitation of a telephone number. For example, an automated voice states something to the effect of “Call from ###-###-####, received ##:## PM. To listen, press one (1).” For convenience of reference and by convention, the operator 9 stores the salient information for the automated verbal recitation in a caller ID register and uses a corresponding time stamp register. Consider a portion of FIG. 2.

In FIG. 2, a caller ID register 30 contains telephone number information (referred to as a “callback number”) associated with a call, while a corresponding time-stamp register 31 contains a time for the call. In the prior art, the telephone number contained in the caller ID register 30 reflects the telephone number from which the call originated. However, as used herein, the telephone number in the caller ID register 30 may be obtained by the caller ID function, or provided by the user. (In actuality, it is commonly known that Caller ID information can be manipulated, for example as an undesired result of calling from within a corporate network).

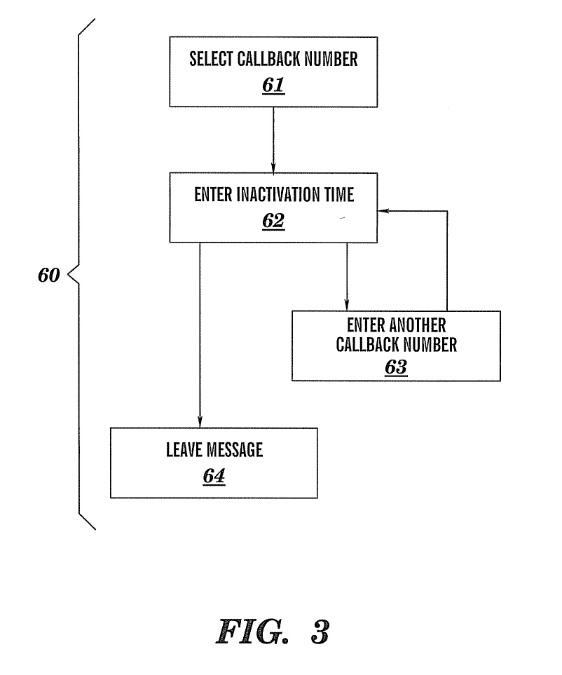

Referring now to FIG. 3, a process for entering callback numbers 60 is depicted. In this exemplary embodiment, the calling feature 10 provides an interface for a caller to manually select callback numbers. In selecting a first callback number 61, the user selects the first callback number from one of the telephone number recognized by the caller ID function and another telephone number (which is manually entered). Once the first callback number has been selected, the user proceeds with entering a corresponding inactivation time 62 for the first callback number. Subsequently, the user proceeds with entering another callback number 63 (a default value may also be provided) and entering the corresponding inactivation time 62. This process continues until the user is satisfied and proceeds with leaving a message 64.

Referring again to FIG. 2, a control script 50 of the operator 9 provides for monitoring a system clock (not shown) of the communications infrastructure 100. In typical embodiments, the control script 50 compares the inactivation time stored in the inactivation time register 33 to the system clock. When parity is realized, the control script 50 replaces the existing callback number in the caller ID register 30 with the callback number from a callback number register 32.

In some embodiments, such as where a plurality of call back numbers and associated inactivation times are used, a callback number data table 40 may be used. The callback number data table 40 includes a plurality of records, which typically include callback numbers and associated inactivation (or activation) times. In these embodiments, the control script 50 provides for prioritizing records of callback number data 42 and each corresponding inactivation time 43 of the callback number data table 40. Typically, the most near term record of callback number data 42 and corresponding inactivation time 43 is loaded into the callback number register 32 and the inactivation time register 33.

Accordingly, when the message recipient ultimately receives the associated message, the message recipient receives an appropriate, time sensitive callback number.

One skilled in the art will recognize that inactivation time is merely one example of an event that may be used to adjust callback numbers. Other examples might include a caller toggling a feature which automatically updates all outstanding messages upon a change in status (such as when a business closes for the day).

Consider an example where a plurality of callback numbers and corresponding times are stored in the callback number data table 40. In this example, the callback number data table 40 include telephone number information that is supplied according to a callers schedule. For example, a caller may wish to leave a message with a first callback number, such as for the business telephone 24 that is useful until the end of the work day. The caller then would like to provide the callback number for the cellular telephone 21 where the caller is reachable during commuting. The caller then would like to provide the callback number for the home telephone 23 where the caller will spend the evening. After a certain point, the caller plans on turning in and does not wish to receive calls. Accordingly, the caller completes the data for the callback number data table 40 solely with entry of the inactivation time (essentially erasing the most recent callback number). In a further embodiment of this example, the callback number data table 40 may provide for restoration of callback numbers in the morning (that is, the control script 50 continues progressing through the callback number data table 40).

Clearly, the callback number data table 40 may be complimented with recursive or other types of instructions. For example, the control script 50 may repeat use of the callback number data table 40 from a certain point. For example, a weekday schedule may be had, while a separate weekend schedule may be used. Accordingly, the control script 50 and the callback number data table 40 may make use of other programming techniques as appropriate.

The calling feature 10 may be implemented on any one of a manual basis, a semi-automatic basis and an automatic basis. As an example, for a manual basis, the caller enters callback information via a keypad on the telephone from which the call is placed. In a semi-automatic basis, the caller might enter a code to initiate an association of the call with a stored callback number data table 40. In an automated basis, the caller may be calling from a phone, such as the cellular telephone 21, for which the callback number data table 40 has previously been built and associated thereto. In some automated embodiments, the callback number data table 40 is automatically downloaded to a compatible communications infrastructure 100 or simply associated with the call (such as for calls placed within a single communications infrastructure 100. In some of these embodiments, automatic transfer may be initiated and completed by use of inaudible signals during a verbal messaging sequence.

Various features of present day communications infrastructures 100 may be used advantageously for implementation of the calling feature 10. For example, the user web access 15 may be used to set up default callback number data tables 40 and make associations (such as with the cellular telephone 21).

Aspects of the calling feature 10 may be included wholly within the operator 9, included at least partially within any of the communications devices 20, or arranged in any manner determined to be appropriate by system designers and users of the communications infrastructure 100.

Examples of various embodiments are now provided.

In a typical embodiment, the calling feature 10 provides a mechanism for manually leaving a callback number. For example, the calling features 10 would provide a prompt at the beginning of a voice mail message. As an example, the calling features 10 would provide an outgoing message such as:
“Sorry, I am not available. Please press the star key (*) to specify a callback number before leaving a message or hit one (1) to leave a message only.”

### Once the caller hits the star key (*), a system prompt requests the caller type in the callback number, press the pound key (#) to use the default number, or press one (1) to leave a message.

The prompt asks to the user to press the pound key (#) to enter a second number, the star key (*) to identify a time this number is better number to use (which prompts with instructions to enter that info). When the call recipient checks the message, the recipient is provided with the time sensitive callback number.

As another example, consider the following sequence:
1. Joe calls Jane;
2. Joe gets Jane's voice mail;
3. Message prompts Joe to enter a callback number if different than (repeats number called from);
4. Joe enters another better number to use and specifies time in near future;
5. The entered time passes;
6. Jane looks at her cell phone or checks her voice mail;
7. Without needing to listen to the voice part of the message, Jane can pull up the callback number to use; and
8. Also automatically, the number shown in Jane's cell phone is the new callback number.

Additionally, it is not uncommon for Web based help center's to allow user's to enter in a phone number on a Web page which, tied to a switch at the phone company, connects the help center to the entered phone number. Neither of these solutions however addresses the widespread use of general daily cell phone use. The closest similarity in that is the standard feature on many traditional and cell phones that store locally a caller's phone number—automatically captured from the connection data.

Allowing callers to specify different numbers on the remote phone's callback entry extends the usability of this feature in a number of ways to simplify the task of locating the original caller and making return phone calls.

As examples of how adding this control extends usability, consider the following problem scenarios:

A) Problem: Joe employee makes a call and leaves a message for someone. Some random corporate number appears in the called phone's caller ID and logged as if it were Joe's number. Joe must verbally specify his direct line in the voice mail message. (Frequently people simply call back the number instead of listening to the message). Solution: Joe hits a certain key to override his caller id number and enters in his direct line. When the call is returned through the call back feature of the phone, the direct line is used.

B) Problem: Joe calls someone from the office but after 5 pm will be on the road and by 5:45 pm will be at home. Joe does not get a cell signal in the office and does not have spare mobile minutes to use at home. He wants the respective lines used when in certain locations. Once again, leaving a voicemail is the only method for explaining which of the 3 phone numbers (office, cell, home). Solution: Joe hits a special key (*1) to override the caller id number. Initially, Joe hits # to leave the current number (the office number) as the initial caller id number. Joe is prompted to leave a message or hit *2 to enter a second caller id number after a certain time. Joe enters his cell phone number and at the prompt enters 1700 to specify 5 pm. Joe hits *3 to enter a third callback number, enters his home phone number, and 1745 to specify 5:45 pm. When the call is returned by hitting the callback button, depending on the time of day, one of the 3 numbers will be used.

C) Problem: Joe is an assistant to a manager who wants to set up a meeting. Joe calls a colleague and leaves a message about the meeting and specifies a call in number to the manager in the voicemail. Solution: Joe overrides the caller ID with the meeting call in number.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing callback number information with a message, the method comprising:
receiving a call completion request from a caller, wherein upon a failure of call completion a messaging sequence is initiated;
upon initiation of the messaging sequence, providing a prompt for selecting a first callback number and a corresponding event designation;
retaining the first callback number and corresponding event designation;
providing another prompt for selecting additional callback numbers and corresponding events to provide a plurality of additional callback numbers and corresponding event designations;
retaining the plurality of additional callback numbers and corresponding event designations;
monitoring for occurrence of designated events; and
upon occurrence of a designated event, providing the corresponding callback number with the message.

2. The method as in claim 1, wherein the designated event comprises one of a time and a status.

3. The method as in claim 1, wherein providing the corresponding callback number comprises displaying the callback number in a caller identification display.

4. The method as in claim 1, wherein providing the corresponding callback number comprises reciting the callback number.

5. The method as in claim 1, wherein selecting at least one of the first callback number and the additional callback numbers comprises one of manually, semi-automatically and automatically selecting.

6. The method as in claim 1, wherein selecting at least one of the first callback number and the additional callback numbers comprises at least one of selecting from a caller identification number and manually entering a callback number.

7. The method as in claim 1, wherein selecting at least one of the first callback number and the additional callback numbers comprises automatically providing callback number data table.

8. The method as in claim 1, wherein monitoring for occurrence of designated events comprises monitoring a system clock.

9. A computer program product stored on machine readable media and comprising instructions for providing callback number information with a message, the instructions comprising instructions for:
receiving a call completion request from a caller, wherein upon a failure of call completion a messaging sequence is initiated;
upon initiation of the messaging sequence, providing a prompt for selecting a first callback number and a corresponding event designation;
retaining the first callback number and corresponding event designation;
providing another prompt for selecting additional callback numbers and corresponding events to provide a plurality of additional callback numbers and corresponding event designations;
retaining the plurality of additional callback numbers and corresponding event designations;
monitoring for occurrence of designated events; and
upon occurrence of a designated event, providing the corresponding callback number with the message.

10. The computer program product as in claim 9, wherein the designated event comprises one of a time and a status.

11. The computer program product as in claim 9, wherein providing the corresponding callback number comprises displaying the callback number in a caller identification display.

12. The computer program product as in claim 9, wherein providing the corresponding callback number comprises reciting the callback number.

13. The computer program product as in claim 9, wherein selecting at least one of the first callback number and the additional callback numbers comprises one of manually, semi-automatically and automatically selecting.

14. The computer program product as in claim 9, wherein selecting at least one of the first callback number and the additional callback numbers comprises at least one of selecting from a caller identification number and manually entering a callback number.

15. The computer program product as in claim 9, wherein selecting at least one of the first callback number and the additional callback numbers comprises automatically providing callback number data table.

16. The computer program product as in claim 9, wherein monitoring for occurrence of designated events comprises monitoring a system clock.

17. A computer program product stored on machine readable media and comprising instructions for providing callback number information with a message, the instructions comprising instructions for:
receiving a call completion request from a caller, wherein upon a failure of call completion a messaging sequence is initiated;
upon initiation of the messaging sequence, providing a prompt for one of manually, semi-automatically and automatically selecting a first callback number and a corresponding event designation, wherein a designated event comprises one of a time and a status
retaining the first callback number and corresponding event designation;
providing another prompt for one of manually, semi-automatically and automatically selecting additional callback numbers and corresponding events to provide a plurality of additional callback numbers and corresponding event designations; wherein automatically selecting comprises automatically providing a callback number data table;
retaining the plurality of additional callback numbers and corresponding event designations;
monitoring a system clock for occurrence of designated events; and
upon occurrence of a designated event, providing the corresponding callback number with the message by at least one of displaying the callback number in a caller identification display reciting the callback number.
